(19) United States
(12) Patent Application Publication
(10) Pub. No.: US 2026/0335172 A1
(43) Pub. Date: Oct. 29, 2026

(54) Anti-Sponge Tangling Massage Structure and Massage Gaming Chair

(71) Applicant: Anji Leisa Furniture Co., Ltd., Zhejiang (CN)

(72) Inventors: Heshuai LI, Zhejiang (CN); Wei HE, Zhejiang (CN)

(73) Assignee: Anji Leisa Furniture Co., Ltd., Zhejiang (CN)

(21) Appl. No.: 19/217,741

(22) Filed: May 23, 2025

(30) Foreign Application Priority Data
Apr. 24, 2025 (CN) 202520789822.6

(51) Int. Cl. A61H 7/00; A61H 39/04

(52) U.S. Cl. CPC A61H 7/004; A61H 39/04; A61H 2201/0149; A61H 2201/0165; A61H 2201/1215; A61H 2201/1604; A61H 2201/1623; A61H 2201/1671; A61H 2203/0431; A61H 2205/02; A61H 2205/081

(57) ABSTRACT

An anti-sponge tangling massage chair has a motor and one or more massage heads driven by the motor. An output terminal of the motor is connected to the massage head via a rotary shaft. The massage head has a base connected to the rotary shaft and a plurality of massage blocks mounted on the base. An end of each massage block away from the base is constructed as a flat contact surface and a protective cover is installed outside the rotary shaft. One end of the protective cover is connected to a side where the base and the massage block are close to the motor and the other end of the protective cover is connected to an end of the rotary shaft close to the motor.

### CROSS-REFERENCE TO RELATED APPLICATIONS

This application claims priority to Chinese Utility Model Patent Application No. 202520789822.6, titled “Anti-Sponge Tangling Massage Structure and Massage Gaming Chair,” filed on Apr. 24, 2025, the content of which, including the amendments thereof, is incorporated herein by reference in its entirety.

### TECHNICAL FIELD

The present disclosure relates to the technical field of massage chairs, particularly to a massage gaming chair equipped with an anti-sponge tangling massage structure.

### BACKGROUND

With the booming development of the gaming industry, massage gaming chairs that combine comfort and functionality have gradually become mainstream in the market. Existing massage gaming chairs typically feature massage components in the headrest and waist pack areas, where motors drive the rotation of massage heads to achieve kneading, pressing, and other functions. However, traditional massage structures suffer from two major technical drawbacks: On one hand, the rotary shafts of the massage heads are relatively thin and directly contact the surrounding high-density sponge filling. When the massage heads operate at high speeds, the sponge is prone to deformation under pressure, becoming embedded in the gaps of the rotary shafts. Under friction, the sponge may be agitated or even torn, leading to sponge damage and massage head jamming, severely compromising the device's operational reliability and lifespan. Current solutions attempt to enhance shaft strength or optimize sponge hardness but fail to structurally prevent direct contact between the sponge and the shaft, leaving the “sponge tangling” issue unresolved. On the other hand, traditional massage heads often employ uniformly sized columnar or conical massage blocks with flat or simple curved side surfaces, resulting in small contact areas and concentrated pressure on the body. This leads to harsh massage intensity, particularly in complex curved areas like the shoulders, neck, and lower back, where excessive localized pressure can cause discomfort, failing to meet users' demand for a gentle massage experience.

Therefore, there is a need to propose an anti-sponge tangling massage structure and a massage gaming chair to address the aforementioned technical issues.

### SUMMARY

The present disclosure provides an anti-sponge tangling massage structure and a massage gaming chair to solve the problems raised in the background.

To achieve the above object, the present disclosure adopts the following technical solutions:

An anti-sponge tangling massage structure comprises a motor and one or more massage heads driven by the motor, with an output terminal of the motor being connected to the massage head via a rotary shaft. The massage head comprises a base connected to the rotary shaft and a plurality of massage blocks mounted on the base, and an end of each massage block away from the base is designed as a flat contact surface; and a protective cover is installed outside the rotary shaft, wherein one end of the protective cover is connected to a side where the base and the massage block are close to the motor, and the other end of the protective cover is connected to an end of the rotary shaft close to the motor.

Additionally, a massage gaming chair is proposed, comprising a seat cushion and a seat backrest. The seat backrest is equipped with a massage headrest and/or a massage waist pack;
when the seat backrest is equipped with the massage headrest, the massage headrest contains the anti-sponge tangling massage structure as described above and a filling sponge; and the seat backrest is provided with a headrest rotation adjustment mechanism, and the massage headrest is installed on an upper part of the gaming chair backrest via the headrest rotation adjustment mechanism; and
when the seat backrest is equipped with the massage waist pack, the massage waist pack contains the anti-sponge tangling massage structure as described above and a filling sponge; and the seat backrest is provided with a waist pack rotation adjustment mechanism, and the massage waist pack is installed on a lower part of the gaming chair backrest via the waist pack rotation adjustment mechanism.

The beneficial effects of the present disclosure compared to prior art are as follows:
1. The massage head in this solution features a flat contact surface, which increases the contact area, enhances massage efficiency, reduces foreign body sensation, and improves comfort during use. Additionally, the inclusion of a protective cover prevents the sponge in the massage headrest or waist pack from being disturbed or even torn, ensuring higher operational reliability.
2. This solution incorporates a headrest rotation adjustment mechanism and a waist pack rotation adjustment mechanism, facilitating adjustments to the position and orientation of the massage headrest and waist pack. This improves comfort during use and prevents discomfort from the hard-built massage core when not in use.
3. This solution integrates a charging cable inside the seat and employs magnetic connection for the charging head, offering both charging convenience and aesthetic appeal.

### BRIEF DESCRIPTION OF DRAWINGS

The drawings, which form part of this application, provide further understanding of the present disclosure. The illustrative embodiments and the descriptions thereof are intended to explain the present disclosure and do not constitute undue limitations. In the drawings:

FIG. 1 is a front schematic view of the massage gaming chair according to an embodiment of the present disclosure;

FIG. 2 is a side schematic view of the massage gaming chair according to an embodiment of the present disclosure;

FIG. 3 is a schematic view of the anti-sponge tangling massage structure according to an embodiment of the present disclosure;

FIG. 4 is another perspective schematic view of the anti-sponge tangling massage structure according to an embodiment of the present disclosure;

FIG. 5 is a schematic view of the headrest rotation adjustment mechanism according to an embodiment of the present disclosure;

FIG. 6 is a schematic view of the eyewear holder according to an embodiment of the present disclosure.

Reference signs: Motor (1); base (2); Massage block (3); Flat contact surface (4); Protective cover (5); First massage block (6); Second massage block (7); Rotary shaft (8); Seat backrest (9); Seat cushion (10); Massage headrest (11); Massage waist pack (12); First elastic strap (13); First universal ring (14); First pass-through slot (15); Second elastic strap (16); Second universal ring (17); Second pass-through slot (18); Limit fabric strip (19); Circuit board (20); Cable outlet (21); Pocket (22); Flap (23); Eyewear holder (24).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

In the present disclosure, to address the issues of existing massage heads where the sponge is agitated or even torn due to the slender seat backrest and insufficiently gentle massage pressure, an anti-sponge tangling massage structure is provided. This structure is installed in the sponge mounting slots of the massage headrest and massage waist pack, including a motor-driven massage head. The base of the massage head is alternately fitted with a first massage block and a second massage block of varying sizes, where the side of the massage block head is curved, and the end away from the base is designed as a flat contact surface. Additionally, a protective cover is installed outside the rotary shaft, with both ends of the cover connected to the base and the end of the rotary shaft close to the motor, respectively. Through this design, the massage contact area is increased, making the massage pressure gentler and more efficient. The protective cover also prevents the sponge from being compressed against the rotary shaft, avoiding sponge tangling and enhancing operational reliability. Below, the anti-sponge tangling massage structure and an embodiment of the massage gaming chair in the present disclosure are described in detail with reference to the accompanying drawings.

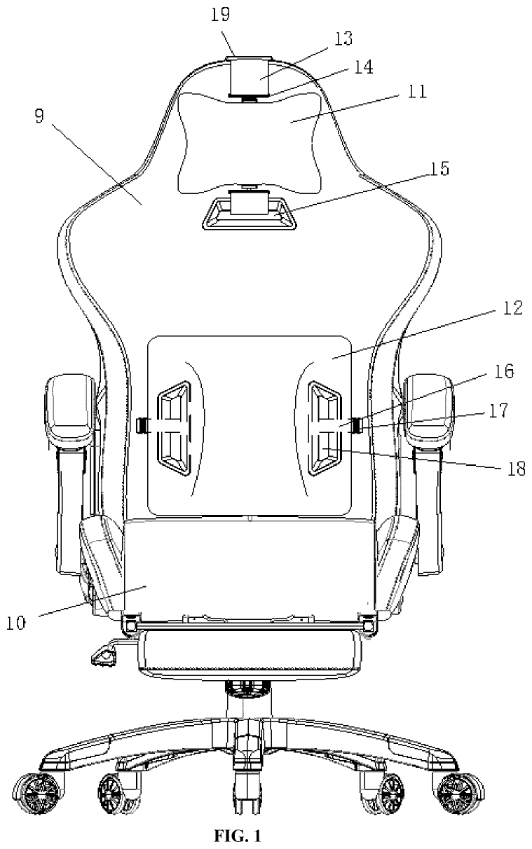

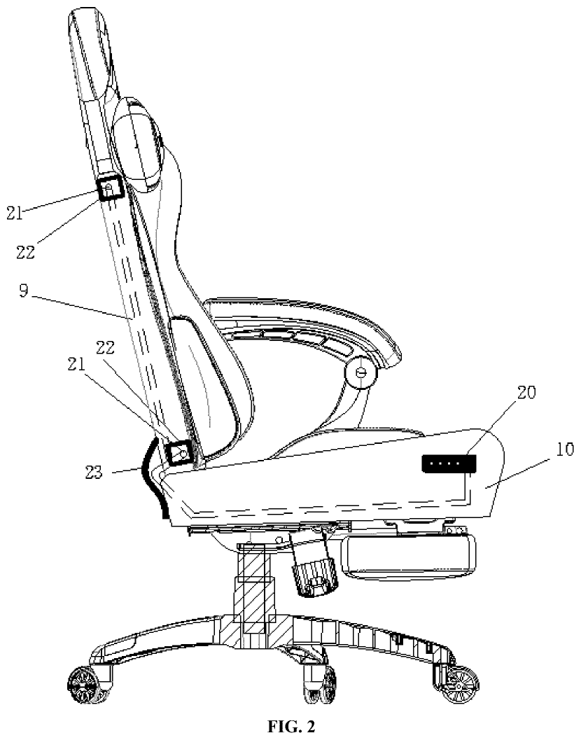

As shown in FIGS. 1 and 2, the massage gaming chair in this embodiment includes a seat cushion 10 and a seat backrest 9, with a massage headrest 11 and a massage waist pack 12 mounted on the seat backrest 9. The seat backrest 9 integrates a headrest rotation adjustment mechanism and a waist pack rotation adjustment mechanism internally. The massage headrest 11 is installed on the upper part of the gaming chair backrest via the headrest rotation adjustment mechanism, while the massage waist pack 12 is installed on the lower part of the gaming chair backrest via the waist pack rotation adjustment mechanism. These adjustment mechanisms enable precise and flexible positioning and angle adjustments for the massage headrest 11 and massage waist pack 12, meeting users' personalized massage needs based on ergonomic principles.

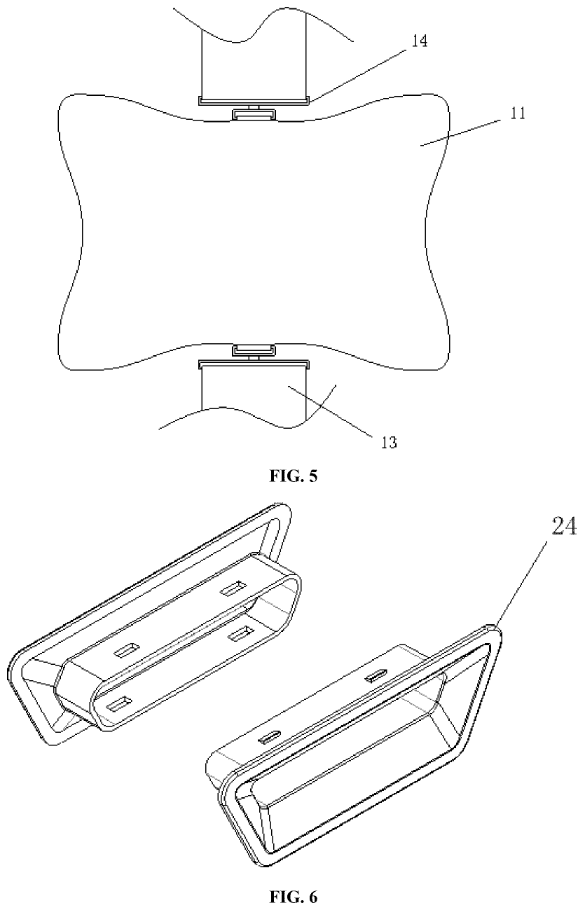

Specifically, referring to FIG. 5, the headrest rotation adjustment mechanism includes a first elastic strap 13 and two first universal rings 14. In this embodiment, the first elastic strap 13 is made of high-elasticity polyester fiber, offering excellent stretch recovery and fatigue resistance, enabling telescopic adjustment under dynamic loads. In other embodiments, the material of the first elastic strap 13 is not limited to polyester fiber but can also include spandex with 500%-800% high elongation, whose superior elasticity provides a comfortable fit; or natural latex, leveraging its breathable and antibacterial properties to meet environmental protection requirements; or TPU, which combines rubber-like elasticity with plastic-like strength, suitable for long-term high-frequency use scenarios; or nylon elastic fiber with high strength and stain resistance, capable of handling complex usage environments. The first universal ring 14 features a dual-ring linkage structure, where two half-rings are nested and connected via a precise rotating core shaft. This core shaft incorporates self-lubricating bearings and a damping adjustment device, enabling 360° omnidirectional fee rotation while maintaining stability and flexibility through preset torque parameters to control rotational resistance.

As shown in FIG. 1, in this embodiment, the upper part of the seat backrest 9 is equipped with an elongated first pass-through slot 15, designed with rounded transitions to prevent stress concentration. The slot walls are treated with anti-slip texture to enhance friction with the strap. The first elastic strap 13 passes through the first pass-through slot 15, with the two first universal rings 14 attached to the two ends of the first elastic strap 13. The ends of the first universal rings 14 away from the first elastic strap 13 are respectively fixed to the upper and lower ends of the massage headrest 11. The connection between the first universal ring 14 and the first elastic strap 13 is achieved by threading the first elastic strap 13 through one buckle of the first universal ring 14 and sewing it to itself. The connection between the first universal ring 14 and the massage headrest 11 involves sewing a fabric strip onto the headrest for the ring to pass through. This design ensures both the aesthetic integrity of the headrest and the stable installation and flexible rotation of the universal rings. Through this headrest rotation adjustment mechanism, the massage headrest 11 can achieve multi-dimensional angle adjustments, meeting a user's head and neck massage needs in various orientations, significantly enhancing ergonomic adaptability.

In other embodiments (not shown), the shape of the first pass-through slot 15 is not limited to a long strip. It can employ a circular slot array for multi-point support and flexible adjustment, be designed as an arc-shaped slot conforming to the human body's curves for enhanced comfort, adopt a T-shaped slot to reinforce structural stability through crosswise intersections, or utilize an elliptical slot to optimize force distribution for precise fixation. These variations further improve the functionality and adaptability of the headrest rotation adjustment mechanism in the massage gaming chair, or any other desired shape.

Referring to FIG. 1, the waist pack rotation adjustment mechanism includes a second elastic strap 16 and two second universal rings 17. In this embodiment, the second elastic strap 16 and the first elastic strap 13 are made of the same high-elasticity polyester fiber material. Alternatively, the second elastic strap 16 can also use stretchable materials such as spandex, natural latex, or rubber. The second universal rings 17 also feature a dual-ring linkage structure, where two half-rings are nested and connected via a precision rotating core shaft to ensure stable and flexible adjustment.

The lower part of the seat backrest 9 is horizontally equipped with two second pass-through slots 18. The shape of the second pass-through slots 18 can similarly adopt the same long strip as the first pass-through slot 15, or any other shape such as circular or arc-shaped. The second elastic strap 16 passes through the two second pass-through slots 18 in sequence, with the two second universal rings 17 positioned at each end of the second elastic strap 16. The ends of the two second universal rings 17 away from the second elastic strap 16 are attached to the left and right sides of the massage waist pack 12. The connection between the second universal ring 17 and the second elastic strap 16 is achieved by threading the second elastic strap 16 through one of the ring buckles and sewing it to itself. The connection between the second universal ring 17 and the massage waist pack 12 involves sewing a fabric strip on the massage waist pack 12 for the second universal ring 17 to pass through. This composite connection ensures structural stability during multi-dimensional adjustments of the massage waist pack 12 while enabling precise adaptation to users' lumbar massage needs in various sitting postures through the flexible rotation of the universal rings, significantly enhancing ergonomic performance and user experience.

As shown in FIGS. 1 and 6, an eyewear holder 24 is installed on both the first pass-through slot 15 and the second pass-through slot 18. The eyewear holder 24 is an existing accessory, and this embodiment does not elaborate on it in detail.

Referring to FIG. 1, in this embodiment, the top of the seat backrest 9 is equipped with a limit fabric strip 19 made of high-strength wear-resistant material. One end of the limit fabric strip 19 is fixed to the left side of the top of the seat backrest 9 using a double-thread lock stitching process, while the other end is sewn to the right side with the same technique, forming a limit ring structure with the top of the backrest. This limit ring, in conjunction with the design at the top of the backrest, works together with the first pass-through slot 15 to create a dual positioning system. The first elastic strap 13 is assembled in a through-type manner, sequentially passing through the first pass-through slot 15 and the limit ring, achieving precise control over the strap's movement trajectory via a dual-path constraint mechanism. This effectively prevents lateral displacement or unintended rotation during use, ensuring the stability and positioning accuracy of the massage headrest 11 during adjustment, thereby enhancing the overall structural reliability and human-machine compatibility.

As shown in FIG. 2, the side of the seat cushion 10 integrates a circuit board 20 with magnetic charging functionality through embedded installation. The circuit board adopts a modular design and high-density integrated layout, encapsulated with waterproof and wear-resistant synthetic leather, exposing only the silicone button switch and magnetic charging interface to ensure operational convenience and electrical safety. The power cable utilizes low-resistance oxygen-free copper cores and fireproof insulated sheathing, routed internally through the high-elastic memory foam fillings of the seat cushion 10 and seat backrest 9 in a concealed manner, adhering to the minimum bending radius design to reduce signal loss and mechanical damage risks. To address the issue of exposed cables at the junction of the seat cushion 10 and seat backrest 9, a flap 23 matching the main material is used for coverage. This flap 23 is secured via precision quilting, achieving an organic integration of concealed electrical wiring, structural protection, and aesthetic integrity.

Specifically, referring to FIGS. 1 and 2, in this embodiment, the cable (not shown) passes through the seat backrest 9 and extends to the lower side edge and upper side edge of the seat backrest 9. The lower side edge and upper side edge of the seat backrest 9 are provided with cable outlets 21, and the cable entering the seat backrest 9 exits through the cable outlets 21. A pocket 22 is sewn at the cable outlet 21, which can serve as a cable storage bag when the cable is not in use. The cables exiting the cable outlets 21 are all equipped with magnetic connectors (not shown), and the cables connected to the massage headrest 11 and massage waist pack 12 also feature magnetic connectors. The magnetic charging port on the circuit board 20 is likewise equipped with a power plug featuring a magnetic connector. The use of magnetic connectors makes charging more convenient and effortless, while also ensuring timely disconnection in case of accidental strong pulling, thereby enhancing safety.

In other embodiments (not shown), the pocket 22 may also be detachably installed at the cable outlet 21, for example, using quick-release structures such as hook-and-loop fasteners, snap buttons, or magnetic buckles. When hook-and-loop fasteners are used, the hook and loop sides of the nylon tape are sewn on the inner side of the pocket 22 and around the cable outlet 21, respectively, achieving a secure connection through tight adhesion. Detachment requires only a gentle pull, facilitating cleaning, maintenance, or replacement with different styles of storage bags. If snap buttons are used, a plurality of sets of snap buttons are installed on the pocket edge and corresponding positions of the seat backrest, enabling quick attachment and detachment through the engagement and separation of the buttons. This connection method offers strong fixation, preventing accidental detachment of the storage bag. The magnetic buckle structure incorporates high-strength permanent magnets or magnetic components at the connection points between the pocket and seat backrest, utilizing magnetic attraction for installation. Its advantage lies in eliminating the need for alignment during connection, and it automatically separates under a certain external force, ensuring both the stability of the storage bag and preventing cable damage due to strong pulling. Additionally, the detachable design allows users to replace storage components with different functions based on actual needs, such as adding expansion modules like USB cable storage compartments or headphone wire clips, further enhancing the product's functionality and personalized experience.

During operation, the massage headrest 11 and massage waist pack 12 of the massage gaming chair in this solution connect to the seat's internal power supply system via magnetic connectors. These magnetic connectors, based on the Hall effect and magnetic coupling principle, feature misinsertion prevention and overload protection functions, ensuring stable and efficient power delivery. When the massage function is not needed, users can perform a 180° flip operation of the massage headrest 11 and massage waist pack 12 through simple manual adjustments without disassembling the components, with the aid of the 360° free rotation capability of the first universal ring 14 in the headrest rotation adjustment mechanism and the second universal ring 17 in the waist pack rotation adjustment mechanism. The universal ring structure incorporates a damping adjustment device and positioning slots, enabling precise positioning at any angle. After flipping, the mechanical massage mechanism inside the massage components will face the seat backrest 9, while the soft high-density sponge cushion layer turns toward the user. This ergonomically optimized layout effectively avoids the pressure and discomfort caused by direct contact between the rigid massage mechanism and the human back, while also reducing the risk of mechanical wear due to prolonged compression, achieving dual improvements in comfort and durability.

Referring to FIGS. 1, 3, and 4, the present disclosure further provides an anti-sponge tangling massage structure. Inside the massage headrest 11 and massage waist pack 12, high-density memory foam is used as the base filling material, and mounting slots are also incorporated. The anti-sponge tangling massage structure is fixed in the mounting slots via bolt structures (not shown). Specifically, the bottom of the anti-sponge tangling massage structure features a boss with an internal threaded hole, while the mounting slot base has a corresponding through-hole. Fastening is achieved by countersunk bolts passing through the through-hole and screwing into the threaded hole.

In other embodiments, the fixation method between the anti-sponge tangling massage structure and the mounting slot is not limited to bolt structures. A pin structure can also be used, offering convenient installation and removal, along with a locking device to prevent detachment. Welding is another option, creating a solid and high-strength connection between the two. Alternatively, a snap-fit structure can be employed, featuring simple design, low cost, quick installation, and some elasticity to absorb external impact forces.

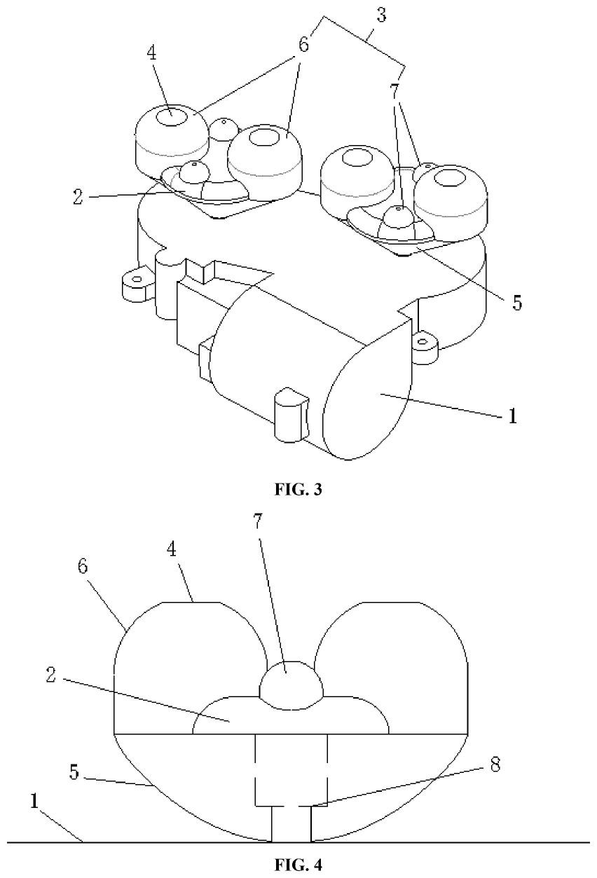

Refer to FIG. 3 for details. The anti-sponge tangling massage structure includes a motor 1 and one or more massage heads driven by the motor 1. In the preferred embodiment, two massage heads are provided to achieve a more balanced and comprehensive massage effect. The output terminal of the motor 1 is rigidly connected to the massage heads via a rotary shaft 8 (as shown in FIG. 4), ensuring stable power transmission. Each massage head consists of a base 2 connected to the rotary shaft 8 and a plurality of massage blocks 3 of varying sizes installed on the base 2. The base 2 not only provides a stable mounting platform for the massage blocks 3 but also effectively dampens vibrations generated by the motor 1. The side profile of the massage blocks 3 is ergonomically designed as a curved surface to closely conform to the physiological curves of areas like the shoulders, neck, waist, and back, enhancing massage fit and comfort. The flat contact surface 4, positioned away from the base 2, disperses massage pressure by increasing the contact area with the body, preventing excessive localized force. Combined with the rotational movement of the massage blocks, it enables diverse massage techniques such as kneading and acupressure, delivering a gentler and more comfortable massage experience while improving efficiency.

As shown in FIG. 3, in this embodiment, the massage blocks 3 adopt a differentiated volume layout, including two first massage blocks 6 and two second massage blocks 7 arranged in a ring on the base 2. The first massage blocks 6 and second massage blocks 7 are alternately spaced, with the first massage blocks 6 being larger in volume than the second massage blocks 7. The larger first massage blocks 6 provide stronger massage pressure, suitable for deep pressing of thick muscle groups like the trapezius and erector spinae, while the smaller second massage blocks 7 focus on precise stimulation of acupoints such as Jianjing and Shenshu. Through scientifically spaced placement, they alternately act on the body during the rotation of the massage head, creating a massage force field that transitions from shallow to deep and balances firmness with gentleness. This differentiated volume configuration and staggered ring arrangement not only diversifies massage intensity and functionality but also ensures balanced force distribution during high-speed operation, effectively enhancing the comprehensiveness and comfort of the massage effect.

Referring to FIG. 4, in the preferred embodiment, the protective cover 5 installed externally on the rotary shaft 8 achieves seamless integration with the edge of the base 2 through mechanical connection. When the sponge inside the massage headrest 11 or massage waist pack 12 is compressed, the sponge in traditional structures tends to move toward the rotary shaft 8 area under pressure and directly contact it, causing fibers to be agitated or even torn due to friction during the operation of the massage head. The arrangement of the protective cover 5 forms a physical barrier, with its edge tightly connected to the base 2, blocking the compression path of the sponge toward the rotary shaft 8, ensuring that the sponge only contacts the smooth surface of the protective cover 5 after compression. Since the protective cover 5 rotates synchronously with the massage head and has a smooth surface, the friction between the sponge and the protective cover 5 is insufficient to drive it to follow the rotation, thereby avoiding sponge damage caused by frictional agitation and ensuring the stable operation of the massage head.

In some embodiments (not shown), the upper surface of the protective cover 5 is designed with a ring-shaped embedded buckle set around the outer edge of the base 2. The outer inclined surface of the buckle tightly interlocks with the U-type groove on the end faces of the base 2 and the massage block 3, automatically aligning during installation and forming a ring-shaped protective base that fits the outer edge of the base, completely eliminating the gap where the sponge could be drawn into the rotary shaft from the base edge. The lower end is screwed onto the shoulder of the rotary shaft 8 via anti-slip threads, complemented by built-in elastic washers to fill connection gaps, ensuring that the protective cover and the rotary shaft maintain a continuous smooth transition surface during high-speed operation, avoiding edge gaps caused by vibration. Specifically, the inner wall of the protective cover 5 is equipped with an arc-shaped flow-guiding structure matching the rotation direction of the massage head, guiding the sponge filler to deform evenly along the curved surface of the cover, dispersing the compression force generated during the operation of the massage head and preventing fiber breakage due to localized stress concentration. Its cross-section features a hyperbolic streamlined shape, forming a gradually widening buffer space from top to bottom, allowing the sponge to naturally conform to the curved surface upon contact with the protective cover and preventing movement toward the rotary shaft 8. All edges of the protective cover 5 and its connection points with the base 2 and rotary shaft 8 adopt curved transition designs, free of right angles or sharp edges. Additionally, the dual-sealing structure of embedded buckles and spiral fastening ensures that the connection interface between the protective cover 5 and adjacent components is completely seamless, physically blocking any possible path for the sponge to contact the rotary shaft.

The protective cover 5 can be made of either high-strength engineering plastic or wear-resistant leather. The former features a micron-level smooth curved surface achieved through polishing, offering excellent friction resistance and chemical stability; the latter employs a highly elastic composite leather material, forming a dense and smooth surface after special coating treatment, combining soft touch with tear-resistant properties. Both materials feature smooth, seamless edges in contact with the sponge, reducing friction and eliminating risks of fiber snagging or embedding. In practical applications, the seamless edge design of the protective cover, combined with its flow-guiding curved surface, effectively prevents direct contact between the sponge and the rotary shaft, solving the “sponge tangling” issue of traditional massage structures and enhancing the reliability and durability of the massage assembly.

In summary, compared to existing structures, the present disclosure achieves the following technical effects: By increasing the number of the first massage block 6 and equipping both the first massage block 6 and the second massage block 7 with flat contact surfaces 4, the contact area is enlarged, resulting in gentler massage pressure, higher massage efficiency, and improved comfort. Additionally, since the rotary shaft 8 of conventional massage heads is relatively thin, the sponge inside the massage headrest 11 or massage waist pack 12 may be compressed toward the rotary shaft 8 and come into contact with the rotary shaft 8. Due to the relationship between friction and pressure, the sponge may be agitated or even torn, affecting the normal operation of the massage head. Therefore, adding the protective cover 5 prevents the sponge from being compressed toward the rotary shaft 8, and the sponge pressed against the protective cover 5 is less likely to rotate and agitate with the massage head, effectively avoiding cotton stirring and improving the operational reliability of the massage device.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ” , “above . . . ” , “on the upper surface of . . . ” , “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

1. An anti-sponge tangling massage structure, comprising a motor (1) a massage head driven by the motor (1), with an output terminal of the motor (1) being connected to the massage head via a rotary shaft (8), wherein the massage head comprises a base (2) connected to the rotary shaft (8) and a plurality of massage blocks (3) mounted on the base (2), and an end of each massage block (3) away from the base (2) is designed as a flat contact surface (4); and a protective cover (5) is installed outside the rotary shaft (8), wherein a first end of the protective cover (5) is connected to the base (2);
wherein a second end of the protective cover (5) is disposed at the motor and connected to an end of the rotary shaft (8), wherein the protective cover (5) extends axially along the rotary shaft from the first end of the protective cover to the second end of the protective cover and fully encloses an outer peripheral surface of the rotary shaft (8) to prevent contact between the rotary shaft (8) and sponge filling material surrounding the protective cover (5); and
wherein the protective cover (5) has an overall shape that: a) tapers from the first end of the protective cover (5) to the second end of the protective cover (5), and b) has an outer wall having a continuously curved contour extending from the first end of the protective cover (5) to the second end of the protective cover (5).

2. The anti-sponge tangling massage structure according to claim 1, wherein the massage blocks (3) comprise two first massage blocks (6) and two second massage blocks (7) arranged annularly on the base (2), wherein the two first massage blocks (6) and the two second massage blocks (7) differ in size and are spaced apart, with the two first massage blocks (6) being larger than the two second massage blocks (7).

3. A massage gaming chair, comprising:
a seat cushion (10) and a seat backrest (9), wherein:
a) the seat backrest (9) is equipped with a massage headrest (11) incorporating the anti-sponge tangling massage structure of claim 1 and a filling sponge; and the seat backrest (9) is provided with a headrest rotation adjustment mechanism, and the massage headrest (11) is mounted on an upper part of the seat backrest via the headrest rotation adjustment mechanism; and/or
b) the seatback (9) is equipped with a massage waist pack (12) incorporating the anti-sponge tangling massage structure of claim 1 and a filling sponge; and the seat backrest (9) is provided with a waist pack rotation adjustment mechanism, and the massage waist pack (12) is installed on a lower part of the seat backrest via the waist pack rotation adjustment mechanism.

4. The massage gaming chair according to claim 3, wherein the headrest rotation adjustment mechanism comprises a first elastic strap (13) and two first universal rings (14); a first pass-through slot (15) is provided on an upper part of the seat backrest (9), and the first elastic strap (13) passes through the first pass-through slot (15); the two first universal rings (14) are respectively attached to both ends of the first elastic strap (13), and ends of the two first universal rings (14) away from the first elastic strap (13) are respectively attached to upper and lower ends of the massage headrest (11).

5. The massage gaming chair according to claim 4, wherein the waist pack rotation adjustment mechanism comprises a second elastic strap (16) and two second universal rings (17); two second pass-through slots (18) are horizontally provided on a lower part of the seat backrest (9), and the second elastic strap (16) sequentially passes through the two second pass-through slots (18); the two second universal rings (17) are respectively attached to both ends of the second elastic strap (16), and ends of the two second universal rings (17) away from the second elastic strap (16) are respectively attached to left and right ends of the massage waist pack (12).

6. The massage gaming chair according to claim 4, wherein a limit fabric strip (19) is attached to a top of the seat backrest (9), with one end of the limit fabric strip (19) being sewn to a left side of the top of the seat backrest (9), another end of the limit fabric strip (19) being sewn to a right side of the top of the seat backrest (9); a limit ring is formed between the limit fabric strip (19) and the top of the seat backrest (9), and the first elastic strap (13) passes through both the first pass-through slot (15) and the limit ring.

7. The massage gaming chair according to claim 3, wherein a circuit board (20) with a magnetic charging port is provided on a side of the seat cushion (10), and a cable outlet (21) is provided on an upper side edge and/or a lower side edge of the seat backrest (9); cables connected to the circuit board (20) extend to the lower side edge and/or the upper side edge of the seat backrest (9) and pass through the cable outlet (21), the cables passing through the cable outlet (21) are all equipped with magnetic connectors, and additional cables connected to the massage headrest (11) and/or massage waist pack (12) are also equipped with magnetic connectors.

8. The massage gaming chair according to claim 7, wherein a pocket (22) is provided at the cable outlet (21).

9. The massage gaming chair according to claim 7, wherein a flap (23) is provided between a rear part of the seat backrest (9) and a rear part of the seat cushion (10).

10. An anti-sponge tangling massage structure, comprising:
a motor (1);
a rotary shaft (8) driven by the motor;
a massage head assembly connected to the rotary shaft;
wherein the massage head assembly comprises:
a base (2);
a massage block (3) installed on the base; and
a protective cover (5) arranged at a bottom of the base, the protective cover (5) surrounding the rotary shaft and having an edge portion mechanically connected to the base for rotation of the base with the protective cover, the edge portion being configured to prevent foreign objects from being entangled during an operation of the rotary shaft), wherein the protective cover (5) extends axially along the rotary shaft from a first end of the protective cover (5) disposed at the base to a second end of the protective cover disposed at the motor and fully encloses an outer peripheral surface of the rotary shaft (8) to prevent contact between the rotary shaft (8) and sponge filling material surrounding the protective cover (5); and
wherein the protective cover (5) has an overall shape that: a) tapers from the first end of the protective cover (5) to the second end of the protective cover (5), and b) has an outer wall having a continuously curved contour extending from the first end to the second end.

11. The anti-sponge tangling massage structure according to claim 10, wherein the massage block (3) has a curved contact surface and a flat contact surface (4).

12. The anti-sponge tangling massage structure according to claim 10, wherein the massage block (3) comprises two first massage blocks (6) and two second massage blocks (7) of different sizes than the two first massage blocks, with the two first massage blocks (6) and the two second massage blocks (7) arranged circumferentially around the rotary shaft at intervals.

13. The anti-sponge tangling massage structure according to claim 10, wherein one end of the protective cover (5) has a mechanical connection to an end of the rotary shaft (8).

14. A massage gaming chair, comprising:
a seat frame, comprising a seat cushion (10) and a seat backrest (9), wherein
a) the seat backrest is equipped with a massage headrest (11) containing the anti-sponge tangling massage structure of claim 10 and a filling sponge; and the seat backrest (9) is provided with a headrest rotation adjustment mechanism, and the massage headrest (11) is installed on an upper part of the seat backrest via the headrest rotation adjustment mechanism; and/or
b) the seat backrest is equipped with a massage waist pack (12) containing the anti-sponge tangling massage structure of claim 10 and a filling sponge; and the seat backrest (9) is provided with a waist pack rotation adjustment mechanism, and the massage waist pack (12) is installed on a lower part of the seat backrest via the waist pack rotation adjustment mechanism.

15. The massage gaming chair according to claim 14, wherein the headrest rotation adjustment mechanism comprises a first elastic strap (13) and two first universal rings (14); a first pass-through slot (15) is provided on the upper part of the seat backrest (9), and the first elastic strap (13) passes through the first pass-through slot (15); the two first universal rings (14) are respectively attached to both ends of the first elastic strap (13), and ends of the two first universal rings (14) away from the first elastic strap (13) are respectively attached to upper and lower ends of the massage headrest (11).

16. The massage gaming chair according to claim 15, wherein the waist pack rotation adjustment mechanism comprises a second elastic strap (16) and two second universal rings (17); two second pass-through slots (18) are horizontally provided on a lower part of the seat backrest (9), and the second elastic strap (16) sequentially passes through the two second pass-through slots (18); the two second universal rings (17) are respectively attached to both ends of the second elastic strap (16), and ends of the two second universal rings (17) away from the second elastic strap (16) are respectively attached to left and right ends of the massage waist pack (12).

17. The massage gaming chair according to claim 15, wherein a limit fabric strip (19) is attached to a top of the seat backrest (9), with one end of the limit fabric strip (19) being sewn to a left side of the top of the seat backrest (9), another end of the limit fabric strip (19) being sewn to a right side of the top of the seat backrest (9); a limit ring is formed between the limit fabric strip (19) and the top of the seat backrest (9), and the first elastic strap (13) passes through both the first pass-through slot (15) and the limit ring.

18. The massage gaming chair according to claim 14, wherein a circuit board (20) with a magnetic charging port is provided on a side of the seat cushion (10), and a cable outlet (21) is provided on an upper side edge and/or a lower side edge of the seat backrest (9); cables connected to the circuit board (20) extend to the lower side edge and/or the upper side edge of the seat backrest (9) and pass through the cable outlet (21), and the cables passing through the cable outlet (21) are all equipped with magnetic connectors.

19. The massage gaming chair according to claim 18, wherein the cables connected to the massage headrest (11) and/or massage waist pack (12) are also equipped with magnetic connectors, and a pocket (22) is provided at the cable outlet (21).

20. The massage gaming chair according to claim 18, wherein a flap (23) is provided between a rear part of the seat backrest (9) and a rear part of the seat cushion (10).
